(19) United States
(12) Patent Application Publication
(10) Pub. No.: US 2005/0033704 A1
(43) Pub. Date: Feb. 10, 2005

(54) Automatic signature verification for retail payment transactions

(75) Inventor: Charles R. Kirk, Raleigh, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/633,992

(22) Filed: Aug. 4, 2003

(51) Int. Cl. G06F 17/60

(52) U.S. Cl. 705/67

(57) ABSTRACT

A method and system for automatically verifying a signature during a retail payment transaction is disclosed. Aspects of the invention include obtaining an electronic signature of a cardholder, and using an electronic signature verification process to automatically verify the electronic signature. The present invention further includes requiring a point-of-sale (POS) operator to manually verify the electronic signature only when an exception occurs during the electronic signature verification.

### FIELD OF THE INVENTION

The present invention relates to methods for processing retail payment transactions, and more particular to a method system for automatically verifying a cardholder's signature during a retail payment transaction.

### BACKGROUND OF THE INVENTION

Retail credit transactions today, especially in the U.S., rely on a cardholder's signature as a primary means for authorization or verification. FIG. 1 is a flow chart illustrating a conventional credit card acceptance process at a retail point-of-sale (POS). The process begins in step 10 when a POS operator enters a charge on the computer electronic register and the credit card of a cardholder is read. In step 12, an authorization process is performed in which data read from the card is sent to a remote credit host for purposes of authorizing the account number and the amount of the charge. After account authorization, the cardholder writes his/her signature on an electronic signature capture device or on a paper receipt in step 14 to confirm the transaction.

According to typical credit card acceptance guidelines, a POS operator is required to verify the cardholder signature in step 16 by visually comparing the provided signature with a signature on the back of the credit card to determine if there is a reasonable match. If the signatures match, then the transaction is completed in step 18. If the signatures do not match, then the operator may cancel in transaction step 20.

The future direction of retail payment transaction processing is towards self-service payment, where the consumer swipes his/her own card through a card reader. The manual signature verification process performed by the POS operator becomes an issue during self-service payment because an extra step is required for the cardholder to present the card to the POS operator for signature verification.

Accordingly, what is needed is improved verification process for retail payment transactions that reduces the need for a POS operator to manually verify signatures. The present invention addresses such a need.

### SUMMARY OF THE INVENTION

The present invention provides a method and system for automatically verifying a signature during a retail payment transaction. Aspects of the invention include obtaining an electronic signature of a cardholder, and using an electronic signature verification process to automatically verify the electronic signature. In a preferred embodiment, digital signatures are stored in a signature database for comparison with the electronic signature captured during the transaction. The present invention further includes requiring a point-of-sale (POS) operator to manually verify the electronic signature when an exception occurs during the electronic signature verification.

According to the method and system disclosed herein, the POS operator only needs to verify the electronic signature when the automatic verification process fails, thereby reducing the need for the POS operator to manually verify signatures in most cases. And when the operator does manually verify the signatures, the electronic signature is added to the signature database, thereby automatically building the database during transactions, instead of requiring a sign-up process whereby cardholders must submit signatures prior to the database becoming operational.

### BRIEF DESCRIPTION OF THE DRAWINGS

FIG. 1 is a flow chart illustrating a conventional credit card verification process at a retail point-of-sale.

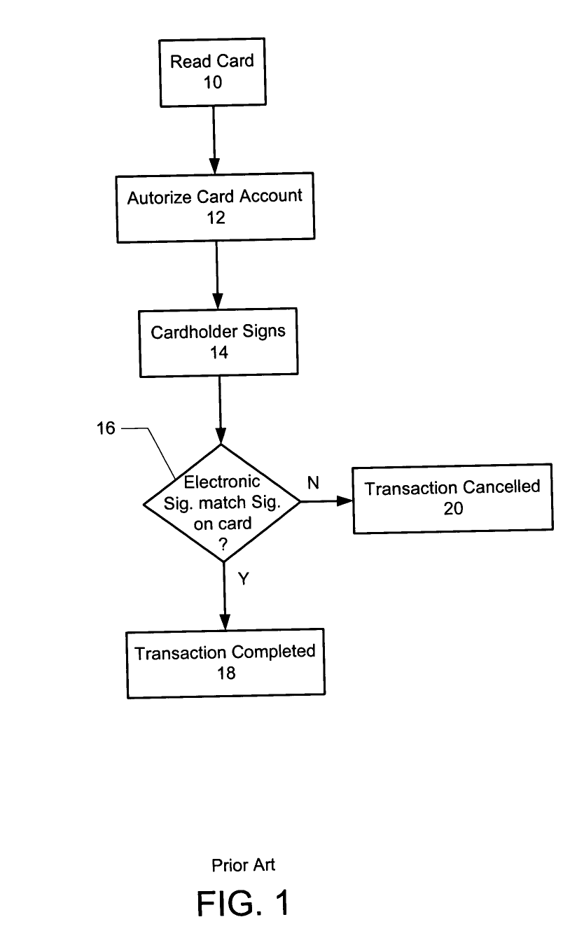

FIG. 2 is a block diagram illustrating an automatic signature verification system for retail transactions in accordance with a preferred embodiment of the present invention.

FIG. 3 is a flow chart illustrating the process for automatically verifying signatures in accordance with a preferred embodiment of the present invention

### DETAILED DESCRIPTION OF THE INVENTION

The present invention relates to retail payment authorization processing, including signature verification. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention takes advantage of current signature capture technology and signature verification technology to perform automatic signature verification, where a POS operator is only involved for initialization and exception processing.

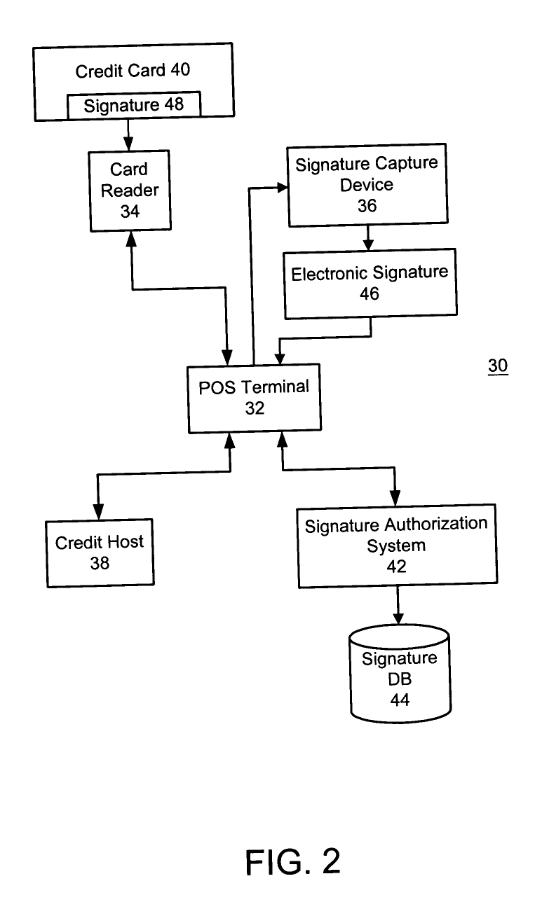

FIG. 2 is a block diagram illustrating an automatic signature verification system for retail transactions in accordance with a preferred embodiment of the present invention. The system 30 includes a point-of-sale (POS) terminal 32 coupled to a card reader 34, a signature capture device 36, and a credit host 38. During a retail transaction, the card reader 34 is used to read data from a credit card 40. The card may include a conventional credit card or a smart card. The POS terminal 32 transmits the data to the credit host 38 for account authentication. The POS terminal 32 also controls the signature capture device 36 for prompting the cardholder to write a signature for electronic capture. In one embodiment, the POS terminal 32, the card reader 34, and the signature capture device 36 are located within the same retail establishment. In an alternative embodiment, the POS terminal 32 may be located remote from the card reader 34 and the signature capture device 36.

According to the present invention, the POS terminal 32 is further coupled to a signature authorization system 42, which includes a signature database 44 that stores digitally captured signatures in association with account numbers (credit card numbers).

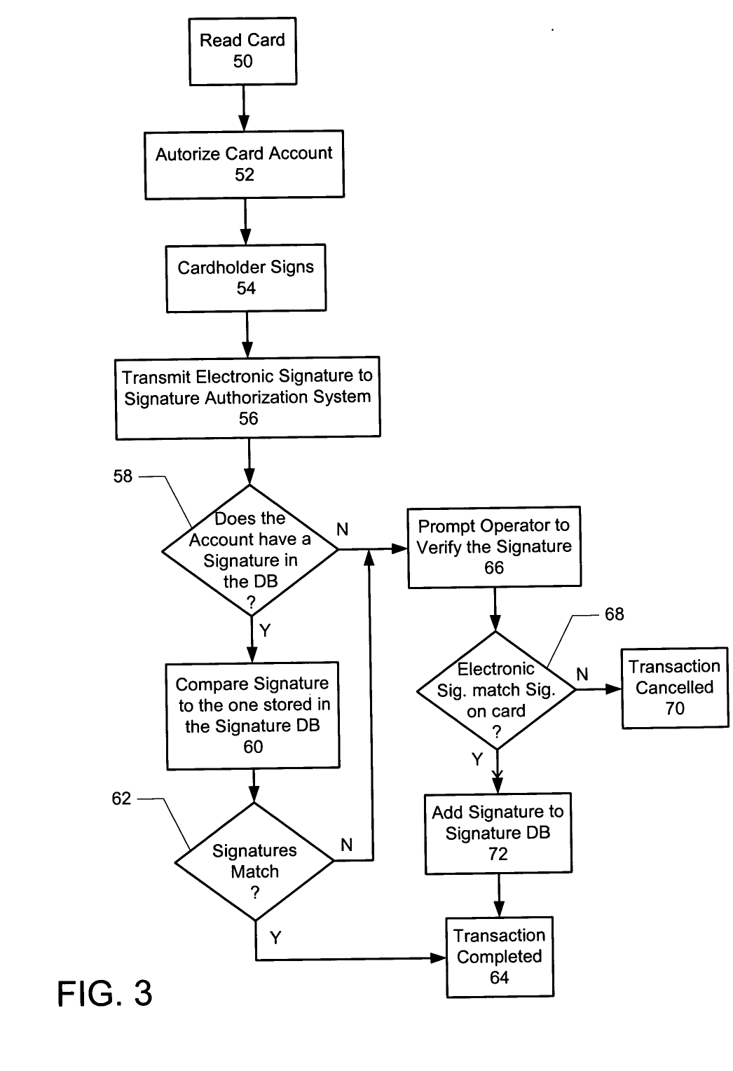

FIG. 3 is a flow chart illustrating the process for automatically verifying signatures in accordance with a preferred embodiment of the present invention, referring to both FIGS. 2 and 3, the process begins in step 50 when a POS operator enters a charge on the POS terminal 32 and the credit card 40 is read. In step 52, an authorization process is performed in which data read from the card 40 is sent to the credit host 38 for authorizing the account number and the amount of the charge. After authorization, the signature of the cardholder is captured on the electronic signature capture device 36 in step 54 to confirm the transaction.

According to the present invention, instead of the POS operator manually verifying the cardholder's signature 46, the signature 46 is automatically verified by the signature authorization system 42. This process begins in step 56 in which the POS terminal 32 transmits the electronic signature 46 to the signature authorization system 42. In step 58, the signature authorization system 42 searches the signature database 44 by account number to determine if the account has a corresponding digital signature on file.

If there is a digital signature associated with account in the signature database 44, then in step 60 the electronic signature 46 is compared to the digital signature(s) stored in the signature database 44 using well-known signature verification algorithms. In step 62, if the signatures match in step 62, then the signature authorization system 42 verifies the electronic signature 46 and the transaction is completed in step 64.

Exceptions to the automatic signature verification process occur when either a digital signature is not found in the signature database 44 for the account in step 58, or the automatic signature verification fails in step 62. When an exception occurs, the POS terminal 32 prompts the POS operator to verify the electronic signature 46 in step 66. In step 68, the POS operator determines whether to verify the signature 46 by comparing the electronic signature 46 with the signature 48 on the card 40.

If the POS operator determines that the signatures 46 and 48 do not match, then the transaction is cancelled in step 70. If the POS operator determines that the signatures 46 and 48 match, then the electronic signature 46 is added to the signature database 44 in step 72, and the transaction completes in step 64.

In a further aspect of the present invention where the POS operator manually verifies the signature 46 and the signature 46 is added to the signature database 44, an automatic method for building the database 44 is provided. Automatically building the signature database 44 in this manner eliminates the need to have a sign-up process where user submit signatures for incorporation into the database 44 prior to the automatic verification process becoming operational. Adding signatures to the same account also allows for variations in a cardholder's signature and reduces the rate at which transactions are incorrectly denied. The signature database 44 may include multiple stored signatures or information garnered from signatures that is used by the automatic signature authentication process.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

1 A method for automatically verifying a signature during a retail payment transaction, the method comprising the steps of:
(a) obtaining an electronic signature of a cardholder;
(b) using an electronic signature verification process to automatically verify the electronic signature; and
(c) requiring a point-of-sale (POS) operator to manually verify the electronic signature when an exception occurs during the electronic signature verification.

2 The method of claim 1 wherein step (b) further includes the step of: comparing the electronic signature to a digital signature stored in signature database under an account of the cardholder using a signature verification algorithm.

3 The method of claim 2 wherein step (b) further includes the step of: searching the signature database by account number to determine if an account of the cardholder has a corresponding digital signature on file.

4 The method of claim 3 wherein step (b) further includes the step of: if the signatures match, verifying the electronic signature and completing the transaction.

5 The method of claim 4 wherein step (c) further includes the step of: determining an exception occurs when a digital signature is not found in the signature database.

6 The method of claim 5 wherein step (c) further includes the step of: determining an exception occurs when the automatic signature verification fails.

7 The method of claim 2 wherein step (c) further includes the step of: if the POS operator verifies the signatures, adding the electronic signature to the signature database, thereby automatically building the signature database.

8 The method of claim 7 wherein step (c) further includes the step of: if the POS operator does not verify the electronic signature, then canceling the transaction.

9 The method of claim 1 wherein step (a) further includes the step of: obtaining the electronic signature of a cardholder after the credit card has been authorized.

10 An automatic signature verification system, comprising:
a card reader for reading data from a credit card;
a signature capture device for capturing an electronic signature from a card holder during a retail transaction;
a point-of-sale (POS) terminal coupled to the card reader and the signature capture device for transmitting the data to a credit host for account authorization; and
a signature database for storing digitally captured signatures in association with account numbers;
wherein once the credit host authorizes the account, an automatic signature verification process is performed in which the electronic signature is compared to a digital signature stored in the signature database in association with the account of the card, and wherein, if the automatic signature verification fails, an operator of the POS terminal is prompted to manually verify the electronic signature with signature on the credit card.

11 The system of claim 10 wherein a signature verification algorithm compares the electronic signature to a digital signature.

12 The system of claim 11 wherein if the signatures match the automatic signature verification process verifies the electronic signature and the transaction is completed.

13 The system of claim 12 wherein the operator is prompted to manually verify the signatures when the digital signature is not found in the signature database.

14 The system of claim 13 wherein if the POS operator verifies the signatures, then the electronic signature is added to the signature database, thereby automatically building the signature database.

15 The system of claim 14 wherein if the POS operator does not verify the electronic signature, then the transaction is cancelled.

16 A computer-readable medium containing program instructions for automatically verifying a signature during a retail payment transaction, the program instructions for:
(a) obtaining an electronic signature of a cardholder;
(b) using an electronic signature verification process to automatically verify the electronic signature; and
(c) requiring a point-of-sale (POS) operator to manually verify the electronic signature when an exception occurs during the electronic signature verification.

17 The computer-readable medium of claim 16 wherein instruction (b) further includes the instruction of: comparing the electronic signature to a digital signature stored in signature database under an account of the cardholder using a signature verification algorithm.

18 The computer-readable medium of claim 17 wherein instruction (b) further includes the instruction of: searching the signature database by account number to determine if an account of the cardholder has a corresponding digital signature on file.

19 The computer-readable medium of claim 18 wherein instruction (b) further includes the instruction of: if the signatures match, verifying the electronic signature and completing the transaction.

20 The computer-readable medium of claim 19 wherein instruction (c) further includes the instruction of: determining an exception occurs when a digital signature is not found in the signature database.

21 The computer-readable medium of claim 20 wherein instruction (c) further includes the instruction of: determining an exception occurs when the automatic signature verification fails.

22 The computer-readable medium of claim 17 wherein instruction (c) further includes the instruction of: if the POS operator verifies the signatures, then adding the electronic signature to the signature database, thereby automatically building the signature database.

23 The computer-readable medium of claim 22 wherein instruction (c) further includes the instruction of: if the POS operator does not verify the electronic signature, then canceling the transaction.

24 The computer-readable medium of claim 16 wherein instruction (a) further includes the instruction of: obtaining the electronic signature of a cardholder after the credit card has been authorized.
